(19) United States
(12) Patent Application Publication
(10) Pub. No.: US 2006/0265837 A1
(43) Pub. Date: Nov. 30, 2006

(54) Hardware for a fully-glazed door

(76) Inventor: Hubert Elmer, Innsbruck (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/553,765

(22) PCT Filed: Oct. 20, 2004
(86) PCT No.: PCT/EP04/11857

§ 371 Date: Oct. 19, 2005

(30) Foreign Application Priority Data
Oct. 20, 2003 (DE) 203 16 238.2

(51) Int. Cl. E05D 7/10

(52) U.S. Cl. 16/229

(57) ABSTRACT

A fitting for an all-glass door with an upper bearing which substantially includes a fitting body with a glass receptacle and/or a clamping device for a glass leaf and with a bearing pin for engagement in a counterbearing at an overpanel or in a frame. The bearing pin is displaceable in a pocket hole. To provide a fitting that resists intrusion after the glass door is installed, the bearing pin of the fitting is secured in such a way that the glass leaf is prevented from being lifted out when the all-glass door is closed.

The invention is directed to a fitting, in particular for all-glass doors, comprising an upper fitting having a fitting body with a clamping device for the glass leaf and with a bearing pin for engaging in a counterbearing at the transom or overpanel.

Fittings of the type mentioned above are sufficiently well known. However, the fittings of the upper counterbearing which is supported at an overpanel above the glass leaf of the glass door are generally oriented transverse to the vertical axis of the glass door. DE 299 24 319 U1 discloses a fitting of this type for the rotatable bearing support of a door leaf at a frame construction. In this case, a fitting is arranged at the top and bottom of the door leaf, respectively, and cooperates with a complementary counter-fitting at a frame construction. The fitting is characterized in that a bearing axis extends in the plane of the door leaf and in that the fitting is fastened in a complementary recess of the door leaf. At the same time, the fitting is divided longitudinally by an intermediate space into fitting parts which are spaced apart at least partially so as to form opposite stop faces. The glass pane is fastened by screw members which engage in the fitting from one side. The upper fitting has a nonadjustable bearing pin.

DE 89 105 69.9 U1 discloses an upper bearing element which has a bearing pin that is displaceable in longitudinal direction of the door (vertical axis). This bearing pin is held by a screw that is arranged orthogonal to the bearing pin and can be adjusted in height by loosening this bearing screw. For this purpose, an elongated hole is provided in the fitting part. The bearing pin penetrates into a pocket hole so that when the door is used the bearing pin disappears into the pocket hole and, after using the door, the bearing pin is pressed out of the bearing due to the orthogonal screw and penetrates into the counterbearing located at the overpanel. A construction of this kind facilitates mounting of the glass door.

DE 298 13 219 U1 discloses a fitting for an all-glass leaf whose bottom fitting parts are terminated by caps.

It is the object of the present invention to provide a fitting which is resistant to break-in after the glass door is installed.

This object is met by the features indicated in claim 1. Advantageous constructions of the subject matter of claim 1 are indicated in the subclaims.

The upper fitting is provided with lift-out protection by means of the fitting arrangement indicated in claim 1. The lift-out protection acts in an outwardly inconspicuous manner because it is arranged below the fitting body, or a clamping device, that is terminated by cover caps.

According to an advantageous further development, the bearing pin is fastened to the fitting body and/or to the clamping device for the all-glass leaf by at least one fastening screw. The fastening screw penetrates into or through the bearing pin orthogonal to the center axis of the bearing pin. The fastening screw is inserted into an elongated hole inside the fitting body and/or the clamping device so that the bearing pin is displaceable in direction of the vertical axis. The thread of the fastening screw penetrates into a threaded bore hole within the bearing pin. By tightening the fastening screw when the bearing pin is moved out, this bearing pin is connected to the fitting body and/or to the clamping device in a frictional and positive engagement.

Due to the fact that the bearing pin is located inside a pocket hole, it is possible to introduce another screw element below the moved out bearing pin, which other screw element likewise penetrates the fitting body and/or the clamping device orthogonal to the center axis of the bearing pin. It is not possible to disassemble the installed all-glass leaf when the door is closed because of the arrangement of the safety screw, namely, because the safety screw is arranged so as to be offset by 180° relative to the fastening screw. This can only be done when the safety screw is unscrewed or loosened on one side of the all-glass door and the fastening screw is unscrewed or loosened on the opposite side. However, this means that the fitting and/or the clamping device must be accessible from both sides of the door leaf.

If only the safety screw were removed after removing the cover on one side of the all-glass door, the bearing pin could not be lowered by reason of the design because the fastening screw holds the bearing pin in its position even when the safety screw is removed. This is due to the fact that the fastening screw, which is offset by 180° relative to the safety screw, is accessible within the space in this case. Not until the all-glass door is opened can the fastening screw also be loosened so that the bearing pin can penetrate into the fitting body and/or into the clamping device. However, this is only possible when the safety screw has been completely removed. When the safety screw is removed, the lower part of the pocket hole in which the bearing pin penetrates is released.

If, on the other hand, a person only loosens the fastening screw, the bearing bolt cannot penetrate down into the pocket hole because of the safety screw that is screwed in on the opposite side.

It is clear that such an arrangement of the safety screw and fastening screw of the bearing pin results in a simple yet effective securing of the bearing pin. Adjustability is not impaired by the safety screw when using the glass door. In this regard, it does not matter how the fitting is constructed.

Further details, features and advantages of the invention are indicated in the following description of a preferred embodiment example with reference to the drawings.

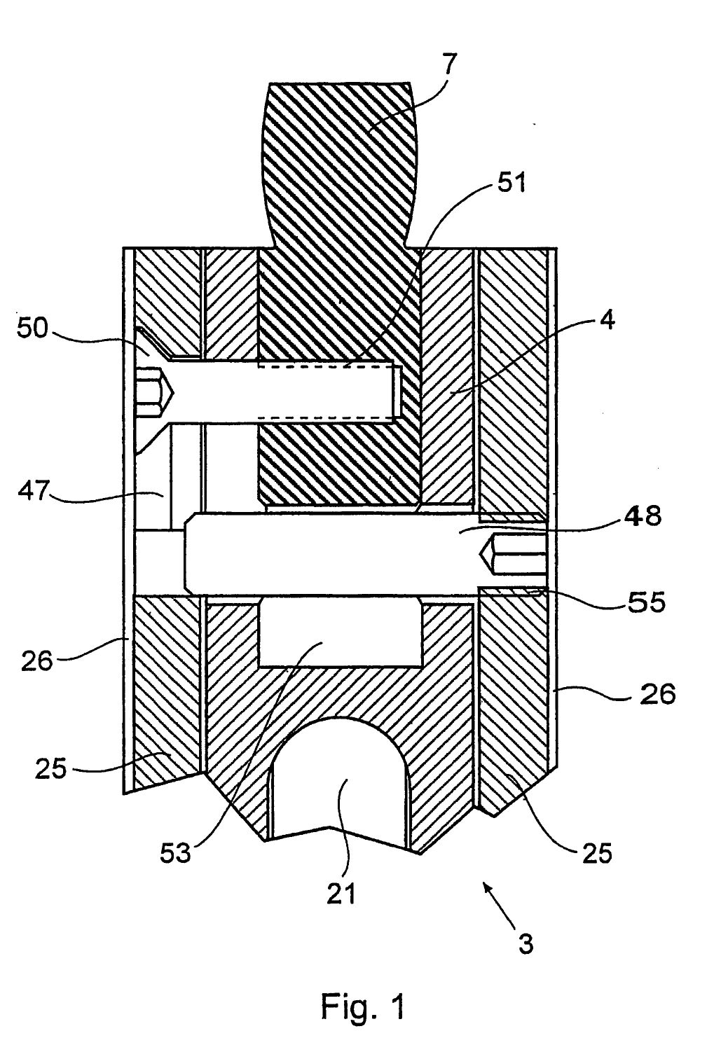

FIG. 1 shows an upper fitting with lift-out protection;

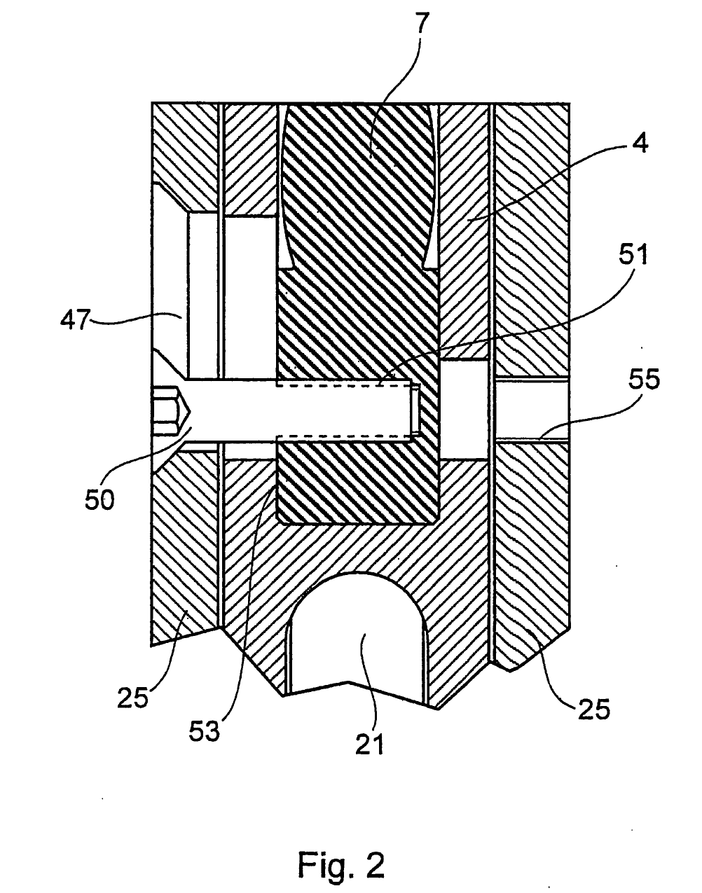

FIG. 2 shows an upper fitting according to FIG. 1 with the bearing pin moved in;

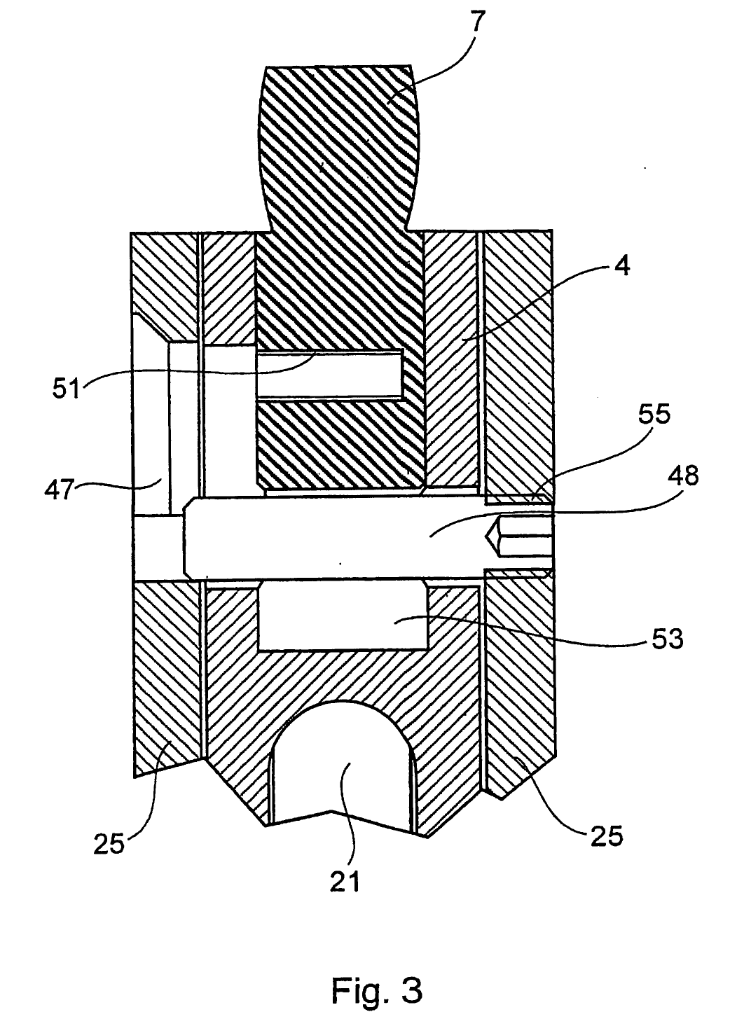

FIG. 3 shows an upper fitting according to FIG. 1 with the fastening screw removed.

FIG. 1 shows an upper fitting that is used for all-glass doors with a glass leaf. Since the invention is only concerned with the upper area of a fitting that is constructed in different ways and since only the lift-out protection is referred to, all other parts not relevant to the invention have been omitted.

The upper fitting 3 substantially comprises a fitting body 4 which has a glass receptacle 21 for the glass leaf of the all-glass door. Located at the upper area of the fitting body 4 is a pocket hole 53 into which a bearing pin 7 of an upper bearing in an overpanel or the like penetrates, this bearing pin 7 being constructed so as to be displaceable. The fitting body 4 is defined laterally by clamping inserts 25 (clamping plates). The clamping inserts 25 are covered by cover panels 26. When the cover panels 26 are removed, as is illustrated in FIGS. 2 and 3, two screw elements within the upper fitting 3, namely, a holding screw 50 and a safety screw 48, are accessible. The holding screw 50 is fitted with its head in an elongated hole oriented in axial direction and with its thread in an internal thread 51 arranged in the bearing pin 7. When the bearing pin 7 moves out (see FIG. 1), the holding screw 50 is tightened so that a frictional and positive engagement occurs between the bearing pin 7 and the upper fitting 3.

Directly below the end of the bearing pin 7 which penetrates into the pocket hole 53 is a safety screw 48 orthogonal to the longitudinal axis of the fitting. The safety screw 48 penetrates the pocket hole 53. The length of the safety screw 48 is adapted to the thickness of the fitting body and clamping inserts. However, the safety screw 48 is arranged so as to be offset by 180° relative to the holding screw 50. This means that when a door leaf is closed, e.g., the safety screw 48 lies outside of the space and the holding screw 50 is located inside the space. Therefore, when a door is closed no one may simultaneously unscrew both screws, namely, the safety screw 48 and the holding screw 50, in order to lower the bearing pin 7 into the pocket hole 53 so as to remove the door leaf from its working position.

In FIG. 2, the safety screw 48 which was screwed into an internal thread 55 of the clamping insert 25 has been removed. It is clear that loosening the holding screw 50 can cause the bearing pin 7 to be lowered only when the safety screw 48 has been removed beforehand. This is shown in FIG. 2.

FIG. 3 shows the situation in which the holding screw 50 is removed from the bearing pin 7 while the inserted safety screw 48 is present in the thread 55 at the same time.

As can be seen from the embodiment example in FIGS. 1 to 3, a door is also operable compared to the cited prior art according to DE 89 105 60.9 U1 when the holding screw 50 is removed since the bearing pin 7 cannot be pushed out of the upper bearing because of the safety screw 48. Due to the fact that the safety screw 48 is offset by 180° relative to the holding screw 50 when the upper fitting 3 is viewed from the top, the entire all-glass door is also protected from being lifted out at the same time.

### REFERENCE NUMBERS

3 upper fitting
4 fitting body
7 bearing pin
21 glass receptacle
25 clamping insert (clamping plate)
26 cover panel
47 elongated hole
48 safety screw
50 holding screw
51 internal thread
53 pocket hole
55 thread

1.-9. (canceled)

10. A fitting for a glass door comprising:
a fitting body extending along an elongated axis between opposite axial ends thereof and having at least one of a receptacle for a glass leaf, and a clamping device for the glass leaf, one of the axial end of the fitting body having an elongated pocket hole extending to one axial of the fitting body; and
a bearing pin displaceably mounted in the elongated pocket hole for retaining the glass door in a frame in which the fitting is mounted, the bearing pin being secured in the elongated pocket hole so that the glass leaf is prevented from being removed from the frame when the door is in a closed position.

11. The fitting of claim 10, further comprising at least one holding screw for fastening the bearing pin to the at least one of the receptacle and the clamping device.

12. The fitting of claim 11, wherein the holding screw extends into the bearing pin orthogonally to the elongated axis of the fitting body.

13. The fitting of claim 12, wherein one of the fitting body and the clamping device has an elongated hole, and the bearing pin has a threaded bore hole aligned with the elongated hole so that the holding screw extends through the elongated hole and threadedly engages the threaded bore hole.

14. The fitting of claim 13, wherein the threaded bore hole is a pocket bore hole.

15. The fitting of claim 13, wherein the threaded bore hole penetrates through the bearing pin.

16. The fitting of claim 10, further comprising a safety screw extending orthogonally to the elongated axis of the fitting body and into or through the elongated pocket hole, wherein the safety screw is spaced from the bearing pin.

17. The fitting of claim 11, further comprising a safety screw extending orthogonally to the elongated axis of the fitting body and into or through the elongated pocket hole, wherein the safety screw is spaced from the bearing pin.

18. The fitting of claim 17, wherein the safety screw and the at least one holding screw extend in opposite directions towards the elongated axis of the fitting body.

19. The fitting of claim 10, further comprising at least one cover plate covering an outer surface of the fitting body.
